(19) United States
(12) Patent Application Publication
(10) Pub. No.: US 2010/0059649 A1
(43) Pub. Date: Mar. 11, 2010

(54) Integrated Frame/Stand for Portable Electronic Devices

(76) Inventor: Pierce Alfred Buxton, San Francisco, CA (US)

Correspondence Address: Hanify & King Professional Corporation, 1055 Thomas Jefferson Street, NW, Suite 400, WASHINGTON, DC, 20007, US

(21) Appl. No.: 12/554,710

(22) Filed: Sep. 4, 2009

Related U.S. Application Data
(60) Provisional application No. 61/094,892, filed on Sep. 6, 2008.

(51) Int. Cl. F16M 11/38; F16M 11/04

(52) U.S. Cl. 248/371; 248/176.3

(57) ABSTRACT

The present invention relates to protective frames for portable electronic devices that can also be used to support the device in an upright display position. In particular, embodiments of the present invention include protective frames for electronic devices that have a support arm attached to, integrated with, and recessed into the frame by a hinge or other secure mechanism that is movably attached, allowing it to be supported in horizontal and vertical positions. Embodiments of the present invention may be used with any type of portable electronic device including portable media players and portable cellular telephones. It may be particularly useful with portable electronic devices that use a touchscreen input.

### CROSS-REFERENCE TO RELATED APPLICATIONS

This application claims the benefit of U.S. Provisional Application No. 61/094,892 filed on Sep. 6, 2008, the entirety of which is incorporated herein by reference.

### FIELD OF THE INVENTION

The present invention relates to protective frames for portable electronic devices that can also be used to support the device in an upright display position. In particular, embodiments of the present invention include protective frames for electronic devices that have a support arm attached to, integrated with, and recessed into the frame by a hinge or other secure mechanism that is movably attached, allowing it to be supported in horizontal and vertical positions. Embodiments of the present invention may be used with any type of portable electronic device including portable media players and portable cellular telephones. It may be particularly useful with portable electronic devices that use a touchscreen input.

### BACKGROUND OF THE INVENTION

There are many frames currently available for use with portable electronic devices; however, there are no frames that include an integrated support arm connected by a hinge that allows the device to be displayed in a horizontal and a vertical position in the open position, and recessed in a way to minimize bulk in the closed position. These frames are primarily intended to protect the portable electronic devices and prevent scratching or more serious structural damage. Most frames on the market completely lack any sort of support to allow the device to stand on its side and be viewed. While there are some frames available that do include some sort of support device, they tend to be bulky and cumbersome, they typically use multiple independent components, are not user-friendly, and do not support the device very well. Such devices are not easily stored in a pocket, purse or holster for easy transport because they frequently have protruding objects on at least one side of the frame. Additionally many of those devices are not capable of supporting the device in both vertical or horizontal orientations with the same support, or are not very stable. Therefore, users currently only have the option of using the device by holding it, by propping it against another object, or by carrying around a separate stand to prop up the device.

Thus, there exists a need in the art for an integrated protective frame with a support arm that can support viewing and controlling the device in both a vertical or horizontal position. There exists an additional need in the art for a frame with an integrated support that, when not being used, adds minimal space and weight comparable to a frame with no support attached.

### SUMMARY OF THE INVENTION

The present invention is directed to a frame for portable electronic devices that is movably connected to a support arm and hinge where the support arm can movable between a first position and a second position and where the support arm is operable to hold up the frame in a vertical or horizontal position.

In one embodiment of the present invention the frame may be formed from an elastomeric material with a large opening in the front portion so that it can be stretched around the portable electronic device.

In another embodiment of the present invention, the frame may include a removable shield on the front portion that covers at least part of the front display on the portable electronic device.

In yet another embodiment of the present invention, the frame may include openings and buttons intended to correspond to features on the exterior of the portable electronic device.

In yet another embodiment of the present invention, the support arm may be formed by at least two components, one made from an elastomeric material and the other made from a more rigid material.

In some embodiments of the present invention, the support arm may include tabs used to lock the support arm in either a first or second position.

### BRIEF DESCRIPTION OF THE DRAWINGS

Further features and advantages of the invention can be ascertained from the following detailed description that is provided in connection with the drawing(s) described below:

FIG. 1 is a front view of one embodiment of a frame (1) movably connected to an integrated support arm (3), with a hinge (6), where the integrated support arm is formed from two separate components, one with upper tabs (7) operable to lock the support arm at an extended angle and lower tabs (5) operable to lock the support arm when it rests in the recess (9) located in the back portion of the frame. The lower tabs lock into the frame in a similarly shaped recess (17). Additionally, the frame contains several openings (11) and buttons (13) on the exterior of the frame for access to a feature of the device enclosed within the frame (1).

FIG. 2 is a back view of one embodiment of a frame (1) movably connected to an integrated support arm (3) with a hinge (6), where the integrated support arm is formed from two separate components, one with upper tabs (7) operable to lock the support arm at an extended angle and lower tabs (5) operable to lock the support arm when it rests in the recess (9) located in the back portion of the frame. Additionally, the frame contains several openings (11) and buttons (13) corresponding to features on the exterior of the frame.

FIG. 3 is a front view of one embodiment of a frame (1) movably connected to an integrated support arm (3), with a hinge (6), where the integrated support arm is formed from two separate components, one with upper tabs (7) operable to lock the support arm at an extended angle and lower tabs (5) operable to lock the support arm when it rests in the recess (9) located in the back portion of the frame. The lower tabs lock into the frame in a similarly shaped recess (17). And, at the bottom of the support arm is an indentation (23). Additionally, the frame contains several openings (11) and buttons (13) on the exterior of the frame for access to features of a devices enclosed within the frame (1).

FIG. 4 is a back view of one embodiment of a frame (1) movably connected to an integrated support arm (3) with a hinge(6), where the body of the frame has an indentation (23) near the support arm to increase access to the support arm. Additionally, the frame contains several openings (11) and buttons (13) corresponding to features on the exterior of the frame.

FIG. 5 is a side view of one embodiment of a frame (1) where the perimeter of the frame has both openings (11) and buttons (13).

FIG. 6 is a front view of one embodiment of a frame (1) movably connected to an integrated support arm (3), where the frame is opened and closed in a clam shell configuration by joining and separating a front piece (1A) and a back piece (1B) at a position indicated by the dashed line (21).

FIG. 7 is a front view of one embodiment of a frame (1) movably connected to an integrated support arm (3) where the bottom portion of the frame (15) can be removed to allow insertion of the electronic portable device.

FIG. 8 is a back view of one embodiment of a frame (1) movably connected to an integrated support arm (3), where the back of the frame also contains additional smaller supports (19).

### DETAILED DESCRIPTION OF THE PREFERRED EMBODIMENT

The present invention relates to an integrated protective frame/support system for portable electronic devices including portable media players, handheld PCs, portable cellular telephones and other similar devices that provides an easy and convenient manner for supporting the device on a flat surface in a comfortable viewing position. In particular, the invention provides a protective frame that may be operatively connected to an integrated support arm designed and shaped similar to the hinged support arm on a tabletop picture frame, which allows the user to stand the protective frame up on one of its edges either horizontally or vertically. The present invention further provides a support arm that can be folded down to lay flush with the protective frame, either directly on top of the back portion of the frame or within a recessed region of the frame, thereby minimizing the amount of space occupied by the invention and the weight of the invention.

In addition, one aspect of the invention is also directed to an integrated frame in which certain of the components may be formed as a single integrated member, rather than a plurality of separate components. It is further contemplated that the components of the present invention may be formed from the same material or different materials. One advantage of the present invention is that it provides improved characteristics compared to the prior art, e.g. it is less bulky, multi-functional, and lighter in weight.

The present invention also relates to an integrated frame with support arm designed to be used with Apple®'s line of portable electronic devices including, but not limited to, the iPhone®, the iPhone® 3G, the iTouch®, the iPod®, as well as future devices not yet on the market. In one embodiment of the present invention, the user is able to place the device on a planar table top, such as a desk, and view and access the touchscreen display of the device while it is standing on a vertical or horizontal side with the aid of the support arm. In that event, the user is able to check emails, surf the web, display photos, and perform other functions best done in a vertical position, and the user is able to watch a movie, watch YouTube™ videos, and perform other functions best done in a horizontal position. By raising the device, it makes it easier for a user to use touchscreen functionality with one hand. As discussed in greater detail below, particular attention is focused on the protective frame, the support arm, and the hinge.

### The Frame

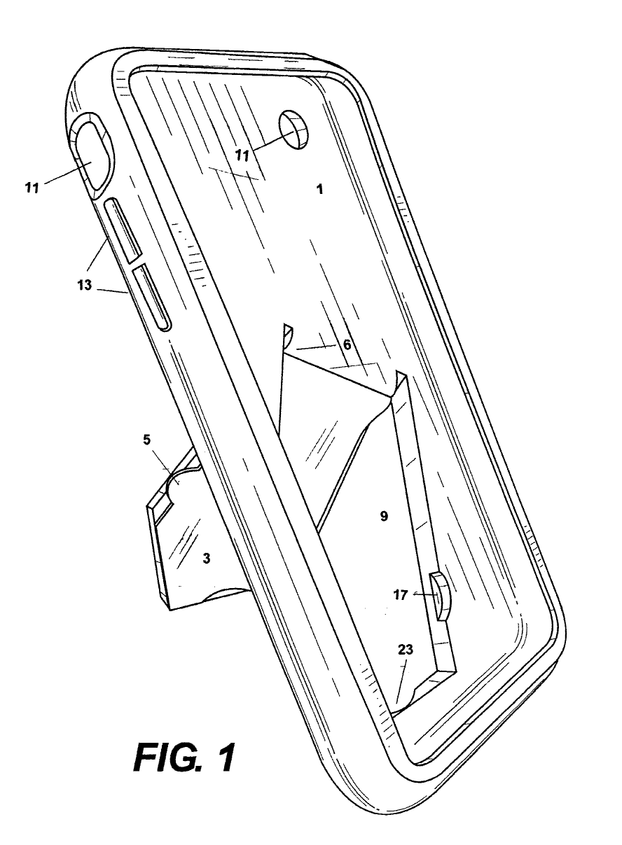

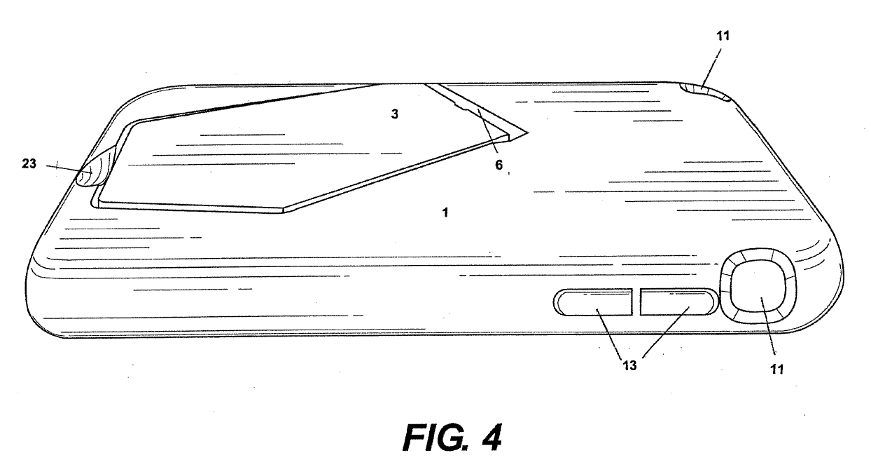

According to one aspect, the protective frame of the present invention may be specifically designed to house and protect portable electronic devices. Generally, as illustrated in FIGS. 1 to 8, the frame includes a front portion, a back portion and a perimeter. In one preferred embodiment, the frame may be rectangular in shape with a back portion, a front portion, and a perimeter of four sides. In preferred embodiments, the frame includes a receiving chamber defined by the inner walls of the frame. The receiving chamber generally constitutes the space occupied by the portable electronic device.

Each frame may be specifically designed for each device that it houses, therefore, the general dimensions of the frame may vary depending upon the size and shape of the device to be inserted therein. For example, the frame may be configured and dimensioned as a rectangle measuring 120 mm by 50 mm. It may have a total thickness of approximately 10 mm. In some cases, a universal frame may be offered that fits multiple devices. Non-limiting examples of portable electronic devices appropriate for use with the present invention include cell phones including those manufactured by Apple, Nokia, Motorola, Sony Erickson, LG, RIM, and Samsung. Preferred embodiments of the present invention include frames specifically designed to house the Apple iPhone® and the Blackberry® by RIM. Additionally, the frame of the present invention may be specifically designed to house handheld PCs, including those manufactured by Dell, IBM, Apple, Sony, HP, Amazon, Gateway, Acer, Asus, and Toshiba. Other examples of devices intended for use with the present invention include portable music players, including MP3 Players, specifically including Apple iPods®, and devices manufactured by Samsung, Sony, Zune®, and SanDisk.

In one embodiment, the front portion of the device is generally defined by a series of edges created around the display of the portable device. The front portion edges of the frame preferably create a border around the display face of the portable device with a minimal recess between the display face of the portable device and the front edges of the frame. Typically, the display of the portable device will encompass a single defined area. However, in alternative embodiments of the present invention, the front portion includes multiple bordered regions defined by a series of edges. Additionally, it is possible that at least one framed region may be designed around a keyboard, touchpad device, or similar feature located on the front of the portable electronic device.

The frame of the present invention may be manufactured from a single material or multiple materials. For example, the entire frame may be formed from molded elastomeric material, such as rubber. Preferred materials for use in the frame include rubber, plastic (including polyurethane and polystyrene), neoprene, glass, leather, and metal. Non-limiting examples of glasses appropriate for use in the present invention include Fused Silica, Sapphire, Borosilicate, Pyrex®, and PolySilicon. Non-limiting examples of metals appropriate for use with the present invention include Aluminum, Copper, Tungsten Carbide, Stainless Steel, and Cobalt Chrome. Molding techniques used to form the frame are known to those skilled in the art. The frame of the present invention may also be formed from a combination of materials. In the event that more than one material is used to construct the frame, the materials may be used together to form a single piece or the materials may be used separately to form parts of the frame that can later be connected. For example, in one embodiment the perimeter and back of the frame may be made from one material, and the second material can be used to construct a shield over the front of the frame. Alternatively, the frame may be formed from two different materials wherein the second material is used to form a cover for an opening used to insert the portable electronic device.

In a preferred embodiment of the present invention, the frame includes a cushion located between the inner walls of the frame and the portable electronic device. The cushion layer is preferably formed from a thin layer of soft foamed elastomeric material.

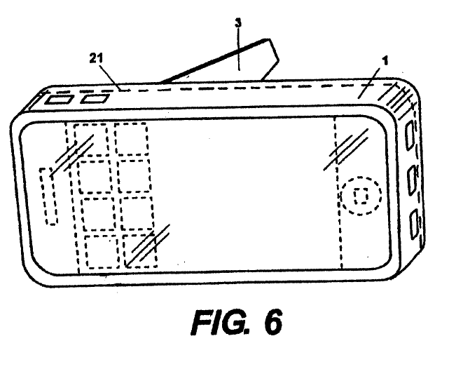

In a preferred embodiment of the present invention, the frame is formed by a front piece and a rear piece that can be joined by coupling systems known to those of skill to allow ready separation, as can be seen in FIG. 6. Preferably, the frame is formed by a front piece and a rear piece that are joined along the perimeter of the frame, as in a clamshell configuration.

In one embodiment of the present invention, the opening in the front of the frame can also be used to insert the portable electronic device into the frame. In a preferred embodiment of the present invention, the frame is made entirely of one elastomeric material that with an opening in the front portion of the frame. One can then insert a portable electronic device into the frame by stretching the frame around the device. Additionally, a shield may optionally be included. If a shield is included in the frame design, it can either be removable or be permanently attached to the device such that it does not completely cover the front portion of the frame. In yet another embodiment, the portable electronic device may be inserted through an opening located in the perimeter of the frame. In that embodiment, the frame may also include a second structure that is used for covering the opening.

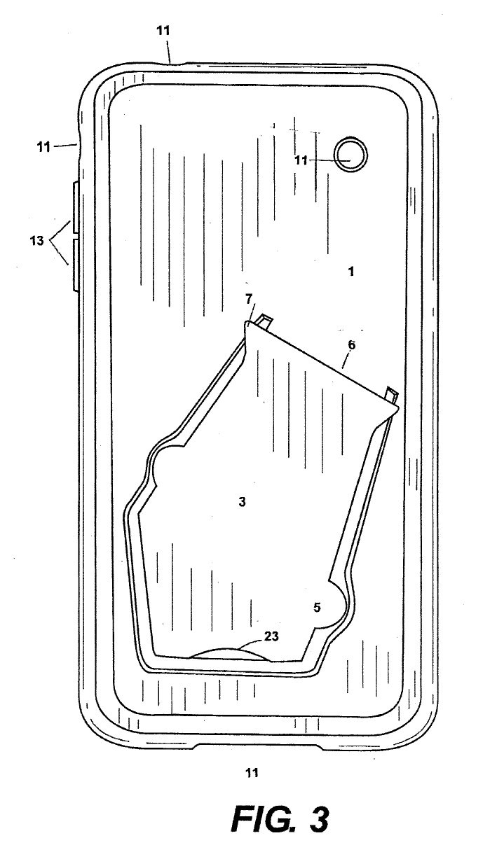

The back portion may optionally have one or more slightly recessed or open areas to receive the at least one support arm so as to rest flush with the back portion (9), as illustrated in FIGS. 1 to 4. Additionally, the back portion may also optionally include an indentation (23) or groove, shown in FIGS. 1 and 3, intended to provide a space between the support arm and the back portion of the frame for the user to grasp the support arm when it is folded against the case. These sunken areas may also be used as seats for adhesive or Velcro® disks as an alternative mounting method. Alternatively, the back portion may have one or more openings into which the at least one support arm can fold down.

The protective frame may have a decorative surface finish which provides an aesthetically pleasing appearance to the exterior of the frame. In one preferred embodiment, the exterior surface of the frame is at least one color. In another preferred embodiment the exterior surface of the frame is multi-colored. In yet another preferred embodiment, the exterior surface of the frame is transparent or translucent. It may also have any kind of finish known in the art. Non-limiting examples of finishes include matte, glossy, opaque, textured, sparkling and sandy.

The frame may be configured and dimensioned to specifically fit the portable electronic device it is intended to house; however, for each unique portable electronic device, various embodiments are possible according to the present invention. The various embodiments may differ in structural design, in material, or in color. It is also contemplated that the frame design can be modified to house portable devices not yet on the market.

As shown in FIGS. 1-8, in preferred embodiments of the present invention, the frame includes one or more openings (11) along the edges to allow the user to connect earphones, power supply adaptors or similar accessories to the portable electronic device without removing the device from the protective frame. Similarly, the frame may also include openings designed to allow the user to view lights or other displays including but not limited to lights indicating the power status, internet connection, or satellite signal, or to provide an opening for a camera, speakers, microphone or the like, located on the front, back or perimeter of the frame.

The perimeter of the frame also optionally includes regions of varying thickness where the frame has some regions of less thickness than other regions, where the regions of less thickness generally correspond to a structure found on the outside of the portable electronic device. In one embodiment of the present invention the frame has at least one region of thickness less than the remaining cover which is specifically designed to cover buttons located along the perimeter of the portable electronic device. In this example, one can manipulate the settings, such as the power or volume settings, on the device using the buttons located on the perimeter without removing the frame. Similarly, the frame may also have regions (13) of equal or greater thickness that protrude out from the exterior surface of the frame to mimic buttons located on the perimeter, front or back of the portable electronic device, as shown in FIGS. 1-8.

### The Shield

In one preferred embodiment of the present invention, the front portion of the frame includes a front shield made from transparent material. The front shield may be permanently attached to the frame or may be a separate removable piece. The front shield may be formed from any transparent material. The transparent member may be any transparent rigid or semi-rigid material, but is preferably glass, plexiglass, plastic, vinyl, acrylics, polymers, or safety glass. In a preferred embodiment, the shield has a thickness that is small enough to allow one to use the touchpad features on the display face of the portable device without removing the shield.

### The Support Arm

As discussed above, the device of the present invention also includes a support arm (3) capable of propping up the frame, shown in FIGS. 1-8. The support arm is preferably pivotally attached to the back of the protective frame, which keeps the frame in an upright vertical or horizontal position on a desk or table top, shelf, or like planar surface. In that location, the lower edge of the support arm and the lower edge of any side of the frame will support the frame with the device inside in a free standing position. In this way, the support arm is operable to supporting the frame in an upright position either horizontally or vertically.

In another embodiment, the support arm may be a separate component that can be attached to any frame for intended for use with a portable electronic device. In particular, the support arm and hinge components may be modular components sold for use with any frame or case known in the art. These modular components may be connected to the frame by an adhesive.

In other embodiments, the support arm may be selectively connected to other portions of the protective frame. These may include, but are not limited to, the front portion and the perimeter. Optionally, a support arm may be selectively connected to more than one portion of the protective frame.

The support arm can be constructed from any rigid or semi-rigid material known to those of ordinary skill in the art. In addition, it may be constructed of a single material or multiple materials. In one preferred embodiment, the support arm is constructed initially out of a rigid or semi-rigid material, and then covered, in whole or in part, by a less rigid elastomeric material. For example, the support arm may initially be constructed from plastic and then covered in rubber to conform to the rest of the device.

Much like the frame component of the present invention, the support arm may vary in aesthetic appearance. For example, the support arm may be a single color, multiple colors, transparent, or translucent. It may also have any kind of finish known in the art. Non-limiting examples of finishes include matte, glossy, opaque, textured, sparkling and sandy.

The support arm of the present invention, much like the frame, may be configured and dimensioned to conform to the dimensions of the specific portable electronic device intended to be housed in the frame. Materials appropriate for use in constructing the support arm will similarly vary depending on the size, weight, and usage of the portable electronic device intended to be housed in the frame

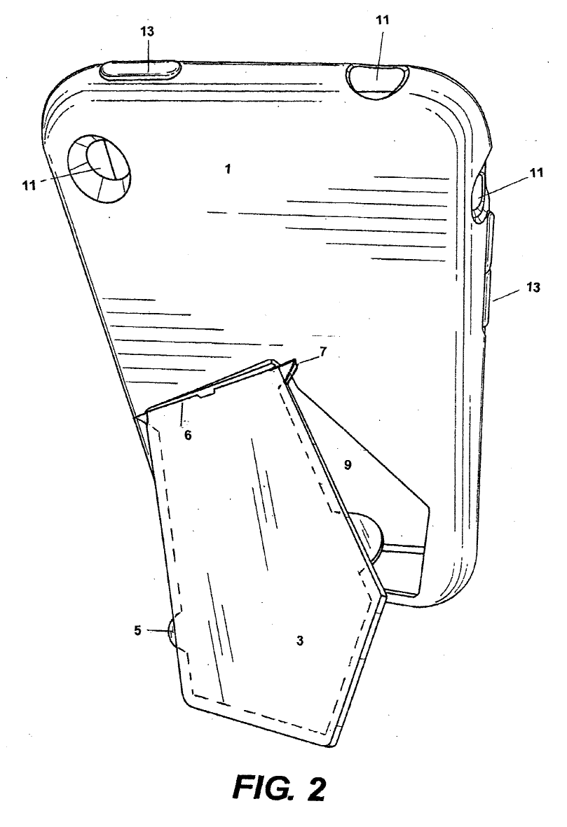

The support arm, in preferred embodiments, does not extend beyond the edges of the perimeter of the frame on any side when it is resting flat on the back portion of the frame. In one preferred embodiment, the support arm rests flat in a recessed area or cut out portion of the back portion of the frame. In yet another preferred embodiment, the support arm rests flat against the back portion of the frame and snaps into that fixed position until released. Snapping mechanisms for use with the present invention are well-known to those skilled in the art. In one preferred embodiment, the support arm may snap into a recess or opening located in the back of the frame using at least one tab (5), shown in FIG. 1. In a more preferred embodiment, the support arm may snap into place using at least two tabs(5), shown in FIG. 2.

When the support arm is extended away from the back portion of the frame it creates a resting angle of the frame that is defined as the angle between the flat planar surface on which the entire invention rests and the back portion of the frame. The extension of the support arm creates a resting angle that is preferably about 85° or less, more preferably about 75° or less, and most preferably about 65° or less.

The shape of the support arm may vary. The support arm may be rounded at the bottom or straight, and may be connected to the frame at an angle. Design of the support arm may vary according to functional or aesthetic purposes. For example, the bottom of the support arm may be rounded upward to allow the invention to rest on a user's shoulder. In one preferred embodiment, the support arm has two bottom edges that run perpendicular to each other in an L shape, comparable to the support arm commonly found on the back of a table top picture frame. In more preferred embodiments, the support arm of the present invention is asymmetrical, and runs diagonally across the back portion of the frame. It will be understood that the design of the support arm may have an impact on the resting angles achieved by the invention in both the horizontal and vertical positions.

### The Hinge

As discussed briefly above, a hinge provides the mechanism for attaching the support arm to the protective frame of the present invention and for allowing the support arm to open, close and possibly adjust the angle of the device. The hinge (6) connects the support arm to the back portion of the frame as shown in FIGS. 1-8. The hinge may be designed according to methods known to those of skill in the art. In one embodiment of the present invention, the hinge is a separate component.

In another embodiment of the present invention, the hinge is part of either the support arm or the frame or both. In yet another embodiment of the present invention, the hinge is not even a hinge at all, rather it is a continuation of the material used to construct the invention from the back portion of the frame, extending on the support arm of the frame. In a further embodiment of the present invention, the hinge is spring-loaded. In the case of a spring-loaded hinge, the hinge may also optionally include a mechanism capable of achieving or locking in a fixed position at multiple resting angles.

The hinge construction may rely on any number of members for limiting the rotation of the hinge, including, brackets, braces, limiters, etc. In a preferred embodiment the hinge is a Living Hinge. Living Hinges, which are well-known in the art, are thin sections of plastic or metal used to connect two segments of a part to keep them together and allow the part to be opened and closed and to stop at a certain degree of angle. The Living Hinge is ideal for the present invention because it is durable, light weight and relatively easy to manufacture. In a preferred embodiment, the Living Hinge will have two stop positions, open and closed. This Living Hinge design is well-known to those skilled in the art. Other non-limiting examples of hinges appropriate for use with the present invention include butt hinges, butterfly hinges, flush hinges, barrel hinges, concealed hinges, continuous hinges, ball bearing hinges, double-acting hinges, knuckle hinges, blind hinges, and pivot hinges.

In another preferred embodiment, shown in FIG. 2, at least one tab (7) is located on the support arm to prevent the support arm from collapsing below a fixed angle. In a more preferred embodiment, when the tab of the support arm is in position, the hinge is prevented from collapsing to an angle of less than about 80°. In a most preferred embodiment, there are two tabs, and when the tab of the support arm is in position, the hinge is prevented from collapsing to an angle of less than about 60°. The inside of the frame may or may not have recesses to allow the tab to move as the support arm is opened and closed.

Additionally the hinge may be attached to the back portion of the frame in a recess to permit the hinge and support arm to lay flush with the back portion of the frame when it is folded toward the back portion of the frame. In a preferred embodiment, shown in FIG. 2, there also is also at least one tab (5) to snap and secure the support arm into place in the closed position. In a preferred embodiment, a recess is included so that the user can easily access and open the support arm when in the closed position.

### Additional Optional Parts

### Hinge Attachments

In one embodiment of the present invention, a hinge attachment, such as a mounting plate, may be used to attach a hinge constructed from a material that is more rigid than the material used to construct the frame. In a preferred embodiment of the present invention, the hinge attachment is made of plastic and attached to the back portion of a frame formed from molded elastomeric material by molding or laminating or otherwise attaching the hinge attachment into the inside of the back portion. The hinge is then attached to the hinge attachment, and the support arm is then attached to the hinge. The hinge attachment may also be connected to the back of the frame using fasteners known in the art. For example, a mounting plate may be used with a number of fastening members which are employed to secure the mounting plate to the back portion of the frame, or the hinge attachment may be molded into the frame and/or support arm. The hinge attachment may be permanently attached to the frame, or it may be removable to reduce the chance of breakage.

### Additional Support Arms

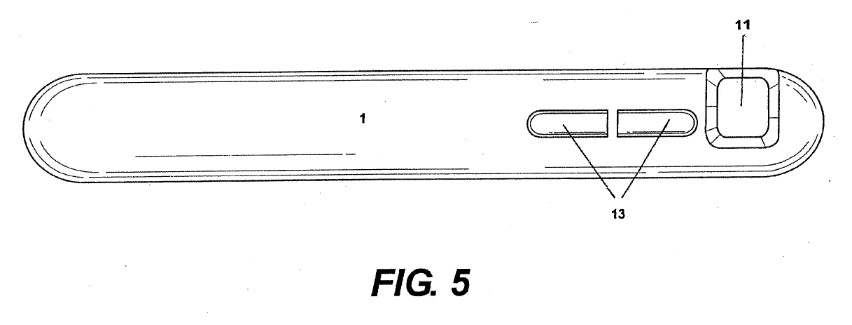

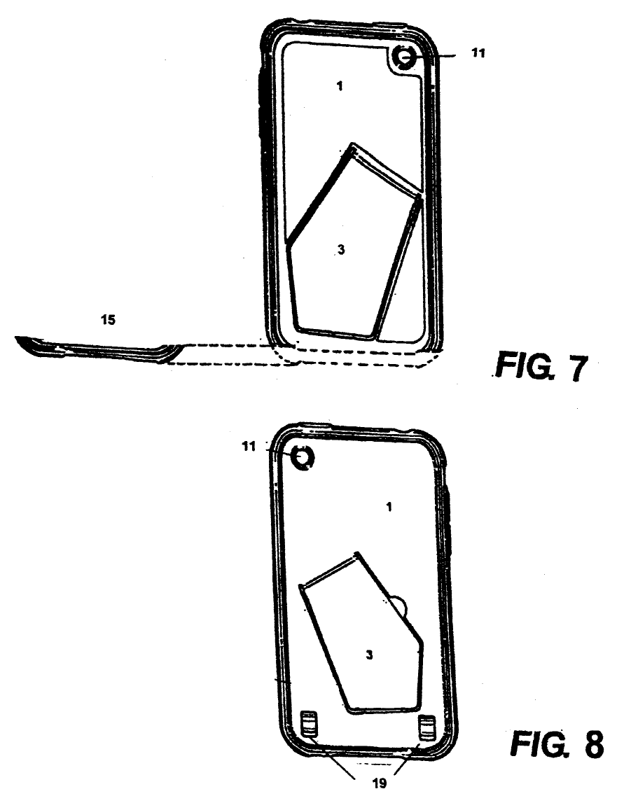

In addition to the primary support arm, embodiments of the present invention also optionally include additional supports. In one embodiment of the present invention, illustrated in FIG. 5, one or more supports(7) that are smaller than the primary support arm are attached to the back portion of the frame. In another embodiment of the present invention, illustrated in FIG. 7, additional support arms(5) are placed on the perimeter of the frame to allow the user to attach plugs to the electronic device that would otherwise protrude too far out to allow the frame to be stable without the support legs. In such an event, the additional support arms may be removable or permanent.

### Examples

The following examples are only representative of the methods and materials for use in the present invention, and are not to be construed as limiting the scope of the invention in any way.

### Example 1

In one preferred embodiment the present invention includes a soft frame designed for use with the Apple® iPhone®. The soft frame is primarily made of rubber, and includes a section that is cut out and specifically shaped to create a living hinge and support arm. The support arm is further attached to a more rigid material to give it stability and provide rigid tabs to hold the support arm open and closed. The rubber covers the entire support arm to provide additional footing support for both the support arm and the frame. The hinge and tabs hold the device up at about 60° in both vertical and horizontal positions, and the support arm folds into a recess in the back of the frame when closed.

### Example 2

In a second embodiment, the invention is designed similar to Example 1, but the support arm is not covered in rubber.

### Example 3

In a third embodiment, the invention is designed similar to Example 1, but the frame is made primarily of rubber with a hinge attachment made of hard material being attached to the back portion of the frame. The hinge is then attached at the hinge attachment and the support arm is attached to the hinge.

### Example 4

In a fourth embodiment, the invention is designed similar to Example 3, but the hinge, attachment, and support arm are all one piece.

### Example 5

In a fifth embodiment, the frame is made from a hard material, such as plastic or metal, and the support arm is cut out of the back portion of the frame. The support arm in this embodiment is attached to the back portion of the frame by connecting to the hinge. The support arm can be made from the same material as the frame or a different material.

### Example 6

In a sixth embodiment of the present invention, the frame has additional moveable support legs on one or more surfaces (either the perimeter or one of either the front or back portions) of the frame to allow the device to be raised to allow a plug or other attachment to be inserted while the device is in the frame. In the case of an Apple® iPhone®, the charger or USB connector plugs into a port at the bottom of the device. In a frame designed for the Apple® iPhone® according to this embodiment, the frame would have one or more hinged pieces on either the front or back portion of the frame that could rotate away from the front portion of the frame toward the table top surface to support the iPhone® along with the support arm, while still allowing the iPhone to be connected to a power supply or other accessory.

### Example 7

In a seventh embodiment, the hinge allows the user to change the orientation from about 0° to about 180° with a locking mechanism to hold the support arm in placed for desired orientations. The locking mechanism may be designed according to various methods known to those of ordinary skill in the art. The locking mechanism may be able to lock at a select number of angles or an infinite number of angles.

What is claimed:

1. An apparatus for holding a portable electronic device comprising:
a frame having a front, a back, and a perimeter;
a support arm that is movably connected to the back of the frame;
wherein the support arm is movable between at least a first position and a second position; and
wherein, in the second position, the frame and device can be supported in a free standing horizontal or vertical position.

2. The apparatus of claim 1, wherein the perimeter of the frame comprises:
an upper portion;
a lower portion; and
two side portions.

3. The apparatus of claim 2, wherein the frame comprises an elastomeric material.

4. The apparatus of claim 3, wherein the support arm comprises an elastomeric material.

5. The apparatus of claim 4, where in the support arm further comprises a second material, wherein the second material is more rigid than the elastomeric material.

6. The apparatus of claim 2, wherein the front of the frame comprises at least one opening large enough to insert the portable electronic device into the receiving chamber.

7. The apparatus of claim 6, wherein, in the first position, the support arm is flush with the back of the frame.

8. The apparatus of claim 2 comprising a locking mechanism operable to temporarily maintain the support arm in the first or second position.

9. An apparatus for use with portable electronic devices, comprising:
a frame; and
a first support arm,
wherein the frame is pivotally connected to the first support arm.

10. The apparatus of claim 9, wherein the frame is pivotally connected to the support arm by a mechanism selected from the group comprising living hinges, spring-loaded hinges, butt hinges, butterfly hinges, flush hinges, barrel hinges, concealed hinges, continuous hinges, ball bearing hinges, double-acting hinges, knuckle hinges, blind hinges, and pivot hinges.

11. The apparatus of claim 10, wherein the frame comprises an opening large enough to allow insertion and removal of the portable electronic device into and out of the receiving chamber.

12. The apparatus of claim 11, wherein the frame further comprises:
a transparent shield that at least partially comprises the front portion of the frame.

13. The apparatus of claim 10, wherein the opening is located on the perimeter of the frame.

14. The apparatus of claim 10 further comprising at least one second support arm, wherein the at least one second support arm is smaller than the first support arm.

15. The apparatus of claim 10, wherein the frame comprises a front piece and a back piece joined along the perimeter.

16. The apparatus of claim 10, wherein the frame comprises indentations or protrusions corresponding to features located on the exterior of the portable electronic device.

17. An apparatus for use with portable electronic devices, comprising:
a frame having a front, a back, and a perimeter; and
a support arm that is movably connected to the frame;
wherein the support arm is movable between a first position and a second position;
wherein, in the second position, the frame is supported in a free standing position;
wherein the perimeter of the frame is defined by an upper portion, a lower portion, and two side portions; and
wherein the support arm allows the frame to stand upright on the lower portion of the perimeter or at least one side portion of the perimeter.

18. The apparatus of claim 17 further comprising a protective layer attached to the inner walls of the frame.

19. The apparatus of claim 17 wherein the frame further comprises a recessed area on the back portion of the frame, wherein the first position consists of the support arm resting flat against the back portion of the frame within the recessed area.

20. The apparatus of claim 19, further wherein the support arm further comprises at least one tab that operably locks the support arm at an angle of no less than 50° in the second position.
